(19) United States
(12) Patent Application Publication
(10) Pub. No.: US 2007/0115378 A1
(43) Pub. Date: May 24, 2007

(54) FCC-COMPLIANT, MOVEMENT ARTIFACT-FREE IMAGE SENSOR ARRAY WITH REDUCED LIGHTING REQUIREMENT

(76) Inventor: Kang-Huai Wang, Saratoga, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/562,932

(22) Filed: Nov. 22, 2006

Related U.S. Application Data
(60) Provisional application No. 60/739,162, filed on Nov. 23, 2005.
(60) Provisional application No. 60/760,079, filed on Jan. 18, 2006.
(60) Provisional application No. 60/760,794, filed on Jan. 19, 2006.

(51) Int. Cl. H04N 5/335

(52) U.S. Cl. 348/308

(57) ABSTRACT

A capsule camera includes a pixel cell array of pixel cells exposed to light from a field of view, an illuminating system that illuminates the field of view, a signal processor receiving and processing data from the pixel cell array, and a control module that causes the pixel cell array to be read out using an improved scanning method. The scanning method includes pre-charging the pixel cells in the pixel cell array, illuminating a field of view of the pixel cells for a predetermined exposure time, and reading out data from the pixel cells only after the illuminating of the field of view is completed. The pre-charging of the pixel cells is carried out over a predetermined time period prior to the field of view being illuminated. The rows of the pixel may be precharged at different times. The time interval between the precharging and the reading out of the pixel cells in each row may be substantially the same. In one instance, the reading out of the pixel cell array is spread out to substantially the time between capturing successive frames of image data. As a result, a transmitter may transmit the processed image data at an average data rate falling substantially within the allowable bandwidth of transmission under the FCC MISC band. In one instance, each row of pixel cells is exposed for the entire duration the illumination system is turned on. A group of pixel cells may be provided outside of the field of view (e.g., at the outer edge of the pixel cell or sensor array. The data that is read from this group of pixels outside the field of view may be used to compensate for thermal and system noise in the data within the field of view.

### CROSS-REFERENCES TO RELATED APPLICATIONS

The present invention related, and claims priority, to (1) U.S. Provisional Patent Application, entitled “InVivo Autonomous Sensor with On-Board Data Storage,” Ser. No. 60/739,162, filed on Nov. 23, 2005; (2) U.S. Provisional Patent Application, entitled “InVivo Autonomous Sensor with Panoramic Camera,” Ser. No. 60/760,079, filed on Jan. 18, 2006; and (3) U.S. Provisional Patent Application, entitled “InVivo Autonomous Sensor with On-Board Data Storage,” Ser. No. 60/760,794, filed on Jan. 19, 2006. These U.S. Provisional Patent Applications (1)-(3) (collectively, the “Provisional Patent Applications”) are hereby incorporated by reference in their entireties. The present application is also related to (1) U.S. Patent Application, entitled “In Vivo Autonomous Camera with On-Board Data Storage or Digital Wireless Transmission In Regulatory Approved Band,” Ser. No. 11/533,304, and filed on Sep. 19, 2006; and (2) U.S. Patent Application, entitled “On-Board Data Storage and Method,” Ser. No. 11/552,880, and filed on Oct. 25, 2006. These U.S. Patent Applications are hereby incorporated by reference in their entirety.

### BACKGROUND OF THE INVENTION

1. Field of the Invention

The present invention relates to swallowable capsule cameras for imaging of the gastro-intestinal (GI) tract. In particular, the present invention relates to an optical sensor array that is suitable for capsule camera applications.

2. Discussion of the Related Art

Devices for imaging body cavities or passages in vivo are known in the art and include endoscopes and autonomous encapsulated cameras. Endoscopes are flexible or rigid tubes that are passed into the body through an orifice or surgical opening, typically into the esophagus via the mouth or into the colon via the rectum. An image is taken at the distal end using a lens and transmitted to the proximal end, outside the body, either by a lens-relay system or by a coherent fiber-optic bundle. A conceptually similar instrument might record an image electronically at the distal end, for example using a CCD or CMOS array, and transfer the image data as an electrical signal to the proximal end through a cable. Endoscopes allow a physician control over the field of view and are well-accepted diagnostic tools. However, they have a number of limitations, present risks to the patient, are invasive and uncomfortable for the patient. The cost of these procedures restricts their application as routine health-screening tools.

Because of the difficulty traversing a convoluted passage, endoscopes cannot reach the majority of the small intestine and special techniques and precautions, that add cost, are required to reach the entirety of the colon. Endoscopic risks include the possible perforation of the bodily organs traversed and complications arising from anesthesia. Moreover, a trade-off must be made between patient pain during the procedure and the health risks and post-procedural down time associated with anesthesia. Endoscopies are necessarily inpatient services that involve a significant amount of time from clinicians and thus are costly.

An alternative in vivo image sensor that addresses many of these problems is capsule endoscopy. A camera is housed in a swallowable capsule, along with a radio transmitter for transmitting data, primarily comprising images recorded by the digital camera, to a base-station receiver or transceiver and data recorder outside the body. The capsule may also include a radio receiver for receiving instructions or other data from a base-station transmitter. Instead of radio-frequency transmission, lower-frequency electromagnetic signals may be used. Power may be supplied inductively from an external inductor to an internal inductor within the capsule or from a battery within the capsule.

An early example of a camera in a swallowable capsule is described in the U.S. Pat. No. 5,604,531, issued to the Ministry of Defense, State of Israel. A number of patents assigned to Given Imaging describe more details of such a system, using a transmitter to send the camera images to an external receiver. Examples are U.S. Pat. Nos. 6,709,387 and 6,428,469. There are also a number of patents to the Olympus Corporation describing a similar technology. For example, U.S. Pat. No. 4,278,077 shows a capsule with a camera for the stomach, which includes film in the camera. U.S. Pat. No. 6,800,060 shows a capsule which stores image data in an atomic resolution storage (ARS) device.

An advantage of an autonomous encapsulated camera with an internal battery is that the measurements may be made with the patient ambulatory, out of the hospital, and with only moderate restrictions of activity. The base station includes an antenna array surrounding the bodily region of interest and this array can be temporarily affixed to the skin or incorporated into a wearable vest. A data recorder is attached to a belt and includes a battery power supply and a data storage medium for saving recorded images and other data for subsequent uploading onto a diagnostic computer system.

A typical procedure consists of an in-patient visit in the morning during which clinicians attach the base station apparatus to the patient and the patient swallows the capsule. The system records images beginning just prior to swallowing and records images of the GI tract until its battery completely discharges. Peristalsis propels the capsule through the GI tract. The rate of passage depends on the degree of motility. Usually, the small intestine is traversed in 4 to 8 hours. After a prescribed period, the patient returns the data recorder to the clinician who then uploads the data onto a computer for subsequent viewing and analysis. The capsule is passed in time through the rectum and need not be retrieved.

The capsule camera allows the GI tract from the esophagus down to the end of the small intestine to be imaged in its entirety, although it is not optimized to detect anomalies in the stomach. Color photographic images are captured so that anomalies need only have small visually recognizable characteristics, not topography, to be detected. The procedure is pain-free and requires no anesthesia. Risks associated with the capsule passing through the body are minimal—certainly the risk of perforation is much reduced relative to traditional endoscopy. The cost of the procedure is less than for traditional endoscopy due to the decreased use of clinician time and clinic facilities and the absence of anesthesia.

As the capsule camera becomes a viable technology for inspecting gastrointestinal tract, various methods for storing the image data have emerged. For example, U.S. Pat. No. 4,278,077 discloses a capsule camera that stores image data in chemical films. U.S. Pat. No. 5,604,531 discloses a capsule camera that transmits image data by wireless to an antenna array attached to the body or provided in the inside a vest worn by a patient. U.S. Pat. No. 6,800,060 discloses a capsule camera that stores image data in an expensive atomic resolution storage (ARS) device. The stored image data could then be downloaded to a workstation, which is normally a personal computer for analysis and processing. The results may then be reviewed by a physician using a friendly user interface. However, these methods all require a physical media conversion during the data transfer process. For example, image data on chemical film are required to be converted to a physical digital medium readable by the personal computer. The wireless transmission by electromagnetic signals requires extensive processing by an antenna and radio frequency electronic circuits to produce an image that can be stored on a computer. Further, both the read and write operations in an ARS device rely on charged particle beams.

A capsule camera using a semiconductor memory device, whether volatile or nonvolatile, has the advantage of being capable of a direct interface with both a CMOS or CCD image sensor, where the image is captured, and a personal computer, where the image may be analyzed. The high density and low manufacturing cost achieved in recent years made semiconductor memory the most promising technology for image storage in a capsule camera. According to Moore's law, which is still believed valid, density of integrated circuits double every 24 months. Meanwhile, CMOS or CCD sensor resolution continues to improve, doubling every few years. Recent advancement in electronics also facilitate development in capsule camera technology. For example, (a) size and power reductions in light emitting diodes (LEDs) promotes the use of LEDs as a lighting source for a capsule camera; (b) new CMOS image sensors also reduce power and component count; (c) the continued miniaturization of integrated circuit allows integrating many functions on a single silicon substrate (i.e., system-on-a-chip or “SOC), resulting in size and power reductions.

One technical challenge for a capsule camera that transmits its images by wireless transmission is the data transmission bandwidth requirement. A capsule camera must transmit its images within the FCC-approved Medical Implant Communication Service (MICS) band, which is allocated to 402-405 MHZ. This band is allocated for medical device because, at these frequencies, the adverse effect of body absorption of the wireless signal is manageable. However, the data bandwidth available in this band limits image resolution and the frame rate. In fact, with this data bandwidth, it is difficult to achieve a reasonable image resolution and at a frame rate that is a few frames per second expected of a capsule camera.

Another technical challenge is the avoidance of artifacts. In a conventional CMOS sensor array, each row of pixel cells are exposed until read out. The read out for each row is conducted sequentially (i.e., each row is read at a different point in time) to share a common set of sense circuits. As each row is required to be exposed for substantially the same length of time, the staggering of the read out time, in turn, requires that each row of pixel cells begins exposure at a different point in time. However, if the subject of the image is moving relative to the camera parallel to the direction of the rows of the sensor array, a line in the field of view perpendicular to that direction would appear to be a slanted line (i.e., the angular orientation of a subject is not correctly preserved). If the subject moves at a non-uniform speed, that line would appear as a curved line. To avoid this artifact, the pixels in the sensor arrays must all be read within 50 ms or so, even though only a few frames per second are required to be taken. Even if the MICS band is to be widened by a few Mhz's, the increase in bandwidth is unlikely to be helpful, as there is also a demand for a higher image resolution, given advances of sensor array technology makes such higher resolution available.

Because a capsule camera is intended to be used exclusively in the GI tract, its operating environment is significantly different from that of a general-purpose camera. Thus, the design of a capsule camera should be optimized for its special operating environment.

### SUMMARY OF THE INVENTION

According to one embodiment of the present invention, a capsule camera includes a pixel cell array of pixel cells exposed to light from a field of view, an illuminating system that illuminates the field of view; a signal processor receiving and processing data from the pixel cell array; and a control module that causes the pixel cell array to be read out using an improved scanning method. The scanning method includes pre-charging the pixel cells in the pixel cell array; illuminating a field of view of the pixel cells for a predetermined exposure time; and reading out data from the pixel cells only after the illuminating of the field of view is completed.

In one embodiment, the pre-charging of the pixel cells is carried out over a predetermined time period prior to the field of view being illuminated. The rows of the pixel may be precharged at different times. In one embodiment, the time interval between the precharging and the reading out of the pixel cells in each row are substantially the same. In one embodiment, the reading out of the pixel cell array is spread out to substantially the time between capturing successive frames of image data. Thus, the image data is read out from the pixel cells over a time period substantially greater than 50 ms.

In one embodiment, a transmitter transmits the processed image data at an average data rate falling substantially within the allowable bandwidth of transmission under the FCC MISC band

In one embodiment, each row of pixel cells is exposed for the entire duration the illumination system is turned on.

In one embodiment, a group of pixel cells are provided masked from light by opaque material at the outer edge of the pixel cell or sensor array. The data that is read from this group of pixels outside the field of view may be used to compensate for thermal and system noise in the data within the field of view.

In one embodiment of the present invention takes advantage of the expected leakage current in the sensor array for a capsule camera. Leakage currents exist in all semiconductor devices and constitute a dominant factor in a CMOS image sensor performance. Because the operating temperature of a capsule camera is largely determined by the body temperature, the specification for the leakage current in its CMOS image sensor is orders of magnitude less than that specified for a general-purpose camera. As a result, the timing requirements for pre-charge, exposure and read out of a pixel cell in a capsule camera is relatively more relaxed, as the charge in the pixel cell is expected to leak more gradually than a general-purpose camera. Further, unlike a general-purpose camera, which must meet the externally imposed, varied lighting conditions, the lighting condition under which a capsule camera operates is primarily controlled by the LED of the capsule camera itself. The present invention takes advantage of these and other factors in the design of a capsule-camera, providing a specialized CMOS sensor of improved performance and at a lesser total system cost.

Prior art CMOS designs, which require the LED be kept uniformly on for both exposure time and the read out time of the sensor array. One embodiment of the present invention shortens this LED on time, thereby providing savings in battery power.

One embodiment of the present invention provides a new CMOS sensor design suitable for use in a capsule camera or endoscope-specific application saves power by shortening the LED on duration requirement and avoids the “slanting” artifact. In addition, the CMOS sensor allows images to be transmitted within the FCC allocated MISC band for medical applications.

The present invention is better understood upon consideration of the detailed description below in conjunction with the accompanying drawings.

### BRIEF DESCRIPTION OF THE DRAWINGS

FIG. 1 shows schematically capsule system 01 in the GI tract, according to one embodiment of the present invention, showing the capsule in a body cavity.

FIG. 2 shows swallowable capsule system 02, in accordance with one embodiment of the present invention.

FIG. 3A is a circuit schematic diagram of a CMOS pixel cell.

FIG. 3B is a circuit symbol for the CMOS pixel cell of FIG. 3A.

FIG. 4 shows a conventional CMOS sensor array constituted by CMOS pixel cells, such as those shown in FIGS. 3A and 3B.

FIG. 5 shows a conventional operation of a CMOS sensor array.

FIG. 6 illustrates an improved scanning scheme, according to one embodiment of the present invention, in which all rows of pixel cells are precharged at substantially the same time—or before—the LED lighting is turned on.

FIG. 7 illustrates another scanning scheme, according to another embodiment of the present invention.

FIG. 8 compares the read out time for images for both conventional and the improved methods of FIGS. 6-7.

FIGS. 9A and 9B compare the operations of wireless capsule camera systems using the conventional scanning method and using the improved methods of the present invention, respectively.

To facilitate cross-referencing among the figures, like elements in the figures are provided like reference numerals.

### DETAILED DESCRIPTION OF THE INVENTION

The Copending Patent Applications disclose a capsule camera that overcomes many deficiencies of the prior art. The present invention provides a capsule camera that is optimized for its special operating environment.

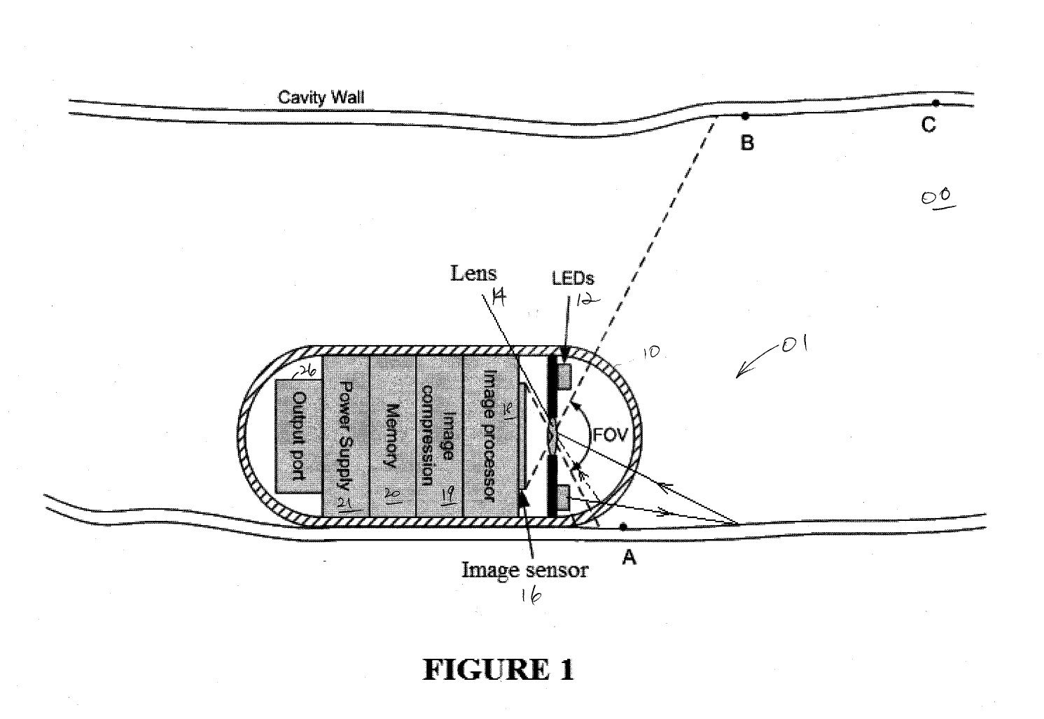

FIG. 1 shows a swallowable capsule system 01 inside body lumen 00, in accordance with one embodiment of the present invention. Lumen 00 may be, for example, the colon, small intestines, the esophagus, or the stomach. Capsule system 01 is entirely autonomous while inside the body, with all of its elements encapsulated in a capsule housing 10 that provides a moisture barrier, protecting the internal components from bodily fluids. Capsule housing 10 is transparent, so as to allow light from the light-emitting diodes (LEDs) of illuminating system 12 to pass through the wall of capsule housing 10 to the lumen 00 walls, and to allow the scattered light from the lumen 00 walls to be collected and imaged within the capsule. Capsule housing 10 also protects lumen 00 from direct contact with the foreign material inside capsule housing 10. Capsule housing 10 is provided a shape that enables it to be swallowed easily and later to pass through the GI tract. Generally, capsule housing 10 is sterile, made of non-toxic material, and is sufficiently smooth to minimize the chance of lodging within the lumen.

As shown in FIG. 1, capsule system 01 includes illuminating system 12 and a camera that includes optical system 14 and image sensor 16. An image captured by image sensor 16 may be processed by image processor 18. Image processor 18 may be implemented in software that runs on a digital signal processor (DSP) or a central processing unit (CPU), in hardware, or a combination of both software and hardware. The processed image may be compressed by an image compression subsystem 19 (which, in some embodiments, may also be implemented in software by DSP 18). The compressed data may be stored in archival system 20. System 01 includes battery power supply 21 and output port 26. Capsule system 01 may be propelled through the GI tract by peristalsis.

Illuminating system 12 may be implemented by LEDs. In FIG. 1, the LEDs are located adjacent the camera's aperture, although other configurations are possible. The light source may also be provided, for example, behind the aperture. Other light sources, such as laser diodes, may also be used. Alternatively, white light sources or a combination of two or more narrow-wavelength-band sources may also be used. White LEDs are available that may include a blue LED or a violet LED, along with phosphorescent materials that are excited by the LED light to emit light at longer wavelengths. The portion of capsule housing 10 that allows light to pass through may be made from bio-compatible glass or polymer.

Optical system 14, which may include multiple refractive, diffractive, or reflective lens elements, provides an image of the lumen walls on image sensor 16. Image sensor 16 may be provided by charged-coupled devices (CCD) or complementary metal-oxide-semiconductor (CMOS) type devices that convert the received light intensities into corresponding electrical signals. Image sensor 16 may have a monochromatic response or include a color filter array such that a color image may be captured (e.g. using the RGB or CYM representations). The analog signals from image sensor 16 are preferably converted into digital form to allow processing in digital form. Such conversion may be accomplished using an analog-to-digital (A/D) converter, which may be provided inside the sensor (as in the current case), or in another portion inside capsule housing 10. The A/D unit may be provided between image sensor 16 and the rest of the system. LEDs in illuminating system 12 are synchronized with the operations of image sensor 16. One function of control module 22 is to control the LEDs during image capture operation.

The output port 26 shown in FIG. 1 is not operational in vivo but uploads data to a work station after the capsule is recovered, having passed from the body. After the capsule passes from the body, it is retrieved. Capsule housing 10 is opened and output port 26 is connected to an upload device for transferring data to a computer workstation for storage and analysis.

A desirable alternative to storing the images on-board is to transmit the images over a wireless link. In one embodiment of the present invention, data is sent out through wireless digital transmission to a base station with a recorder. Because available memory space is a lesser concern in such an implementation, a higher image resolution may be used to achieve higher image quality. Further, using a protocol encoding scheme, for example, data may be transmitted to the base station in a more robust and noise-resilient manner. One disadvantage of the higher resolution is the higher power and bandwidth requirements. One embodiment of the present invention, described below, requires substantially less bandwidth to achieve image transmission. In this manner, a lower data rate is achieved, so that the resulting digital wireless transmission falls within the narrow bandwidth limit of the regulatory approved Medical Implant Service Communication (MISC) band. Consequently, it is feasible to transmit a greater distance (e.g. 6 feet) outside the body, so that the antenna for picking up the transmission is not required to be in an inconvenient vest, or to be attached to the body. Provided the signal complies with the MISC requirements, such transmission may be in open air without violating FCC or other regulations.

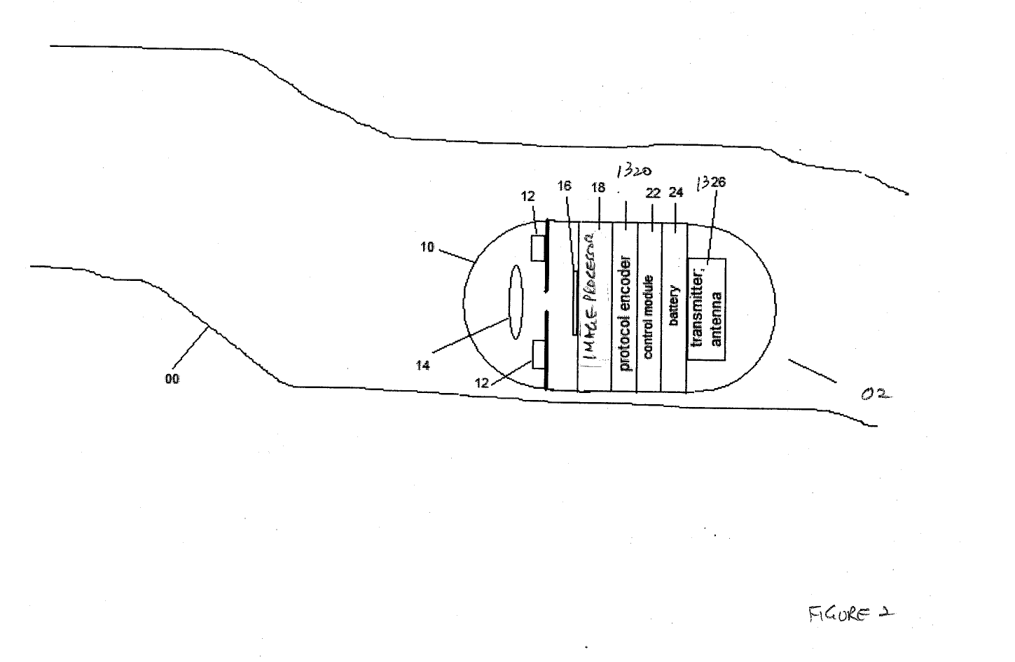

FIG. 2 shows swallowable capsule system 02, in accordance with one embodiment of the present invention. Capsule system 02 may be constructed substantially the same as capsule system 01 of FIG. 1, except that archival memory system 20 and output port 26 are no longer required. Capsule system 02 also includes communication protocol encoder 1320 and transmitter 1326 that are used in the wireless transmission. The elements of capsule 01 and capsule 02 that are substantially the same are therefore provided the same reference numerals. Their constructions and functions are therefore not described here again. Communication protocol encoder 1320 may be implemented in software that runs on a DSP or a CPU, in hardware, or a combination of software and hardware, Transmitter 1326 includes an antenna system for transmitting the captured digital image.

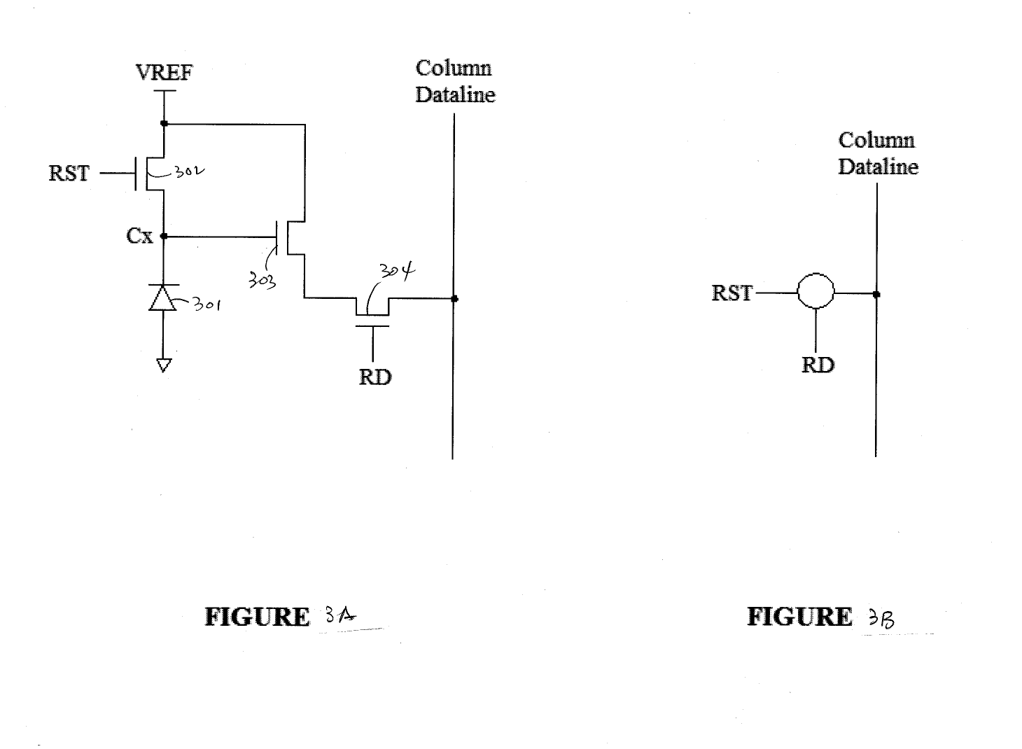

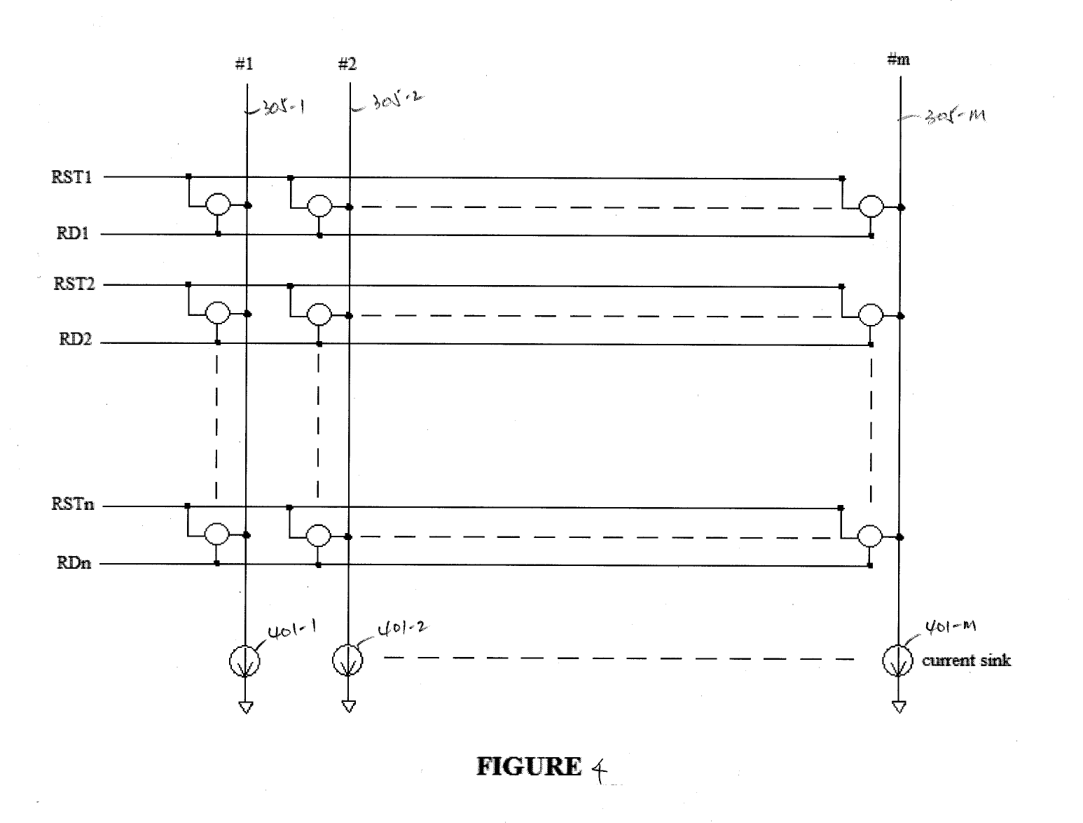

The present invention provides a timing and control scheme to operate a CMOS sensor array. FIG. 3A is a schematic circuit for a three-transistor (3T) pixel cell. The schematic circuit is provided for illustrative purpose only, the timing and control scheme of the present invention can be used in conjunction with this and other cell designs, some of which may have a different number of transistors in a pixel cell than is shown in FIG. 3A. The pixel cell of FIG. 3A may be represented symbolically by the symbol of FIG. 3B.

As shown in FIG. 3A, the 3T pixel cell includes a photo-diode 301 connected in series to a power supply voltage VREF through a transistor 302, which is controlled by a control or “reset” signal RST. When RST is asserted, transistor 302 is conducting, thereby precharging node Cx (representing the capacitance of the PN junction in photodiode 301) to substantially the voltage VREF. When light impinges on photodiode 302, a current is produced by the energy of the photons generating charge carriers in the semiconductor. The amount of charge carried off by the current is a function of both light intensity and the length of time the photodiode is exposed to the light. The voltage at Cx controls the gate of pass transistor 303, which is connected between supply voltage VREF and “read” transistor 304. Read transistor 304 is controlled by control signal RD. When control signal RD is asserted, a current flow from power supply voltage VREF to column dataline 305. The effective resistance of conducting transistors 303 and 304 is a function of the voltage at node Cx. The voltage on column dataline 305 is sensed by sense amplifiers.

Leakage currents due to thermal noise exist in all semiconductor devices and constitute a dominant factor in a CMOS image sensor performance. The amount of leakage current is a function of temperature. Over the expected operating range of a general purpose camera, the leakage current may vary over several orders of magnitude. Therefore, in a conventional general purpose camera, the voltage at node Cx has to be read as soon as the exposure is complete, to avoid severe inaccuracy resulting from a large leakage current that may drain the charge at node Cx.

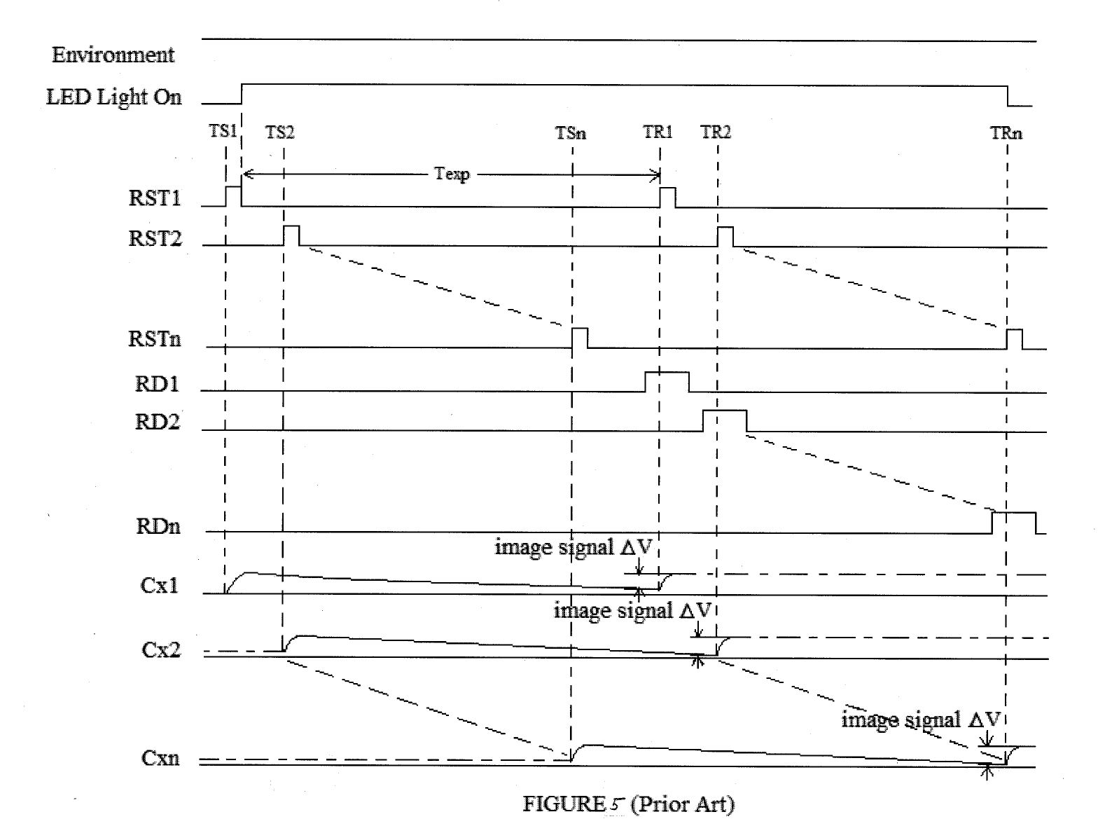

FIG. 4 shows an n row by m column pixel cell array. As shown in FIG. 4, each row of pixel cells in the pixel cell array receives one of reset signals RST1-RSTn. Each of RST1-RSTn provides the RST signal at each pixel cell of the row. In addition, each row of pixel cells receives one of read-out signals RD1-RDn. Each of RD1-RDn provides control signal RD at each pixel cell of the row. Pixel cells in a column of the pixel cell array are connected to a common column dataline, one of column datalines 305-1 to 305-m. Each column dataline is connected to a constant current source, one of constant current sources 401-1 to 401-m. Since the current is substantially constant in each of current sources 401-1 to 401-m, when only one of read-out signals RD1-RDn is asserted, the voltage on each column dataline is a function of the series resistance of the cascaded pass transistors (i.e., pass transistors 303 and 304) in the pixel cell. The voltage may be measured when the corresponding one of read-out signals RD1-RDn is asserted. That voltage is based on the voltage on node Cx of that pixel cell, as discussed above. Thus, by sensing the voltage on the column data-line, the charge in the capacitor of photodiode 301 of that pixel cell, representing the amount of light impinging on the photodiode of the pixel cell may be measured.

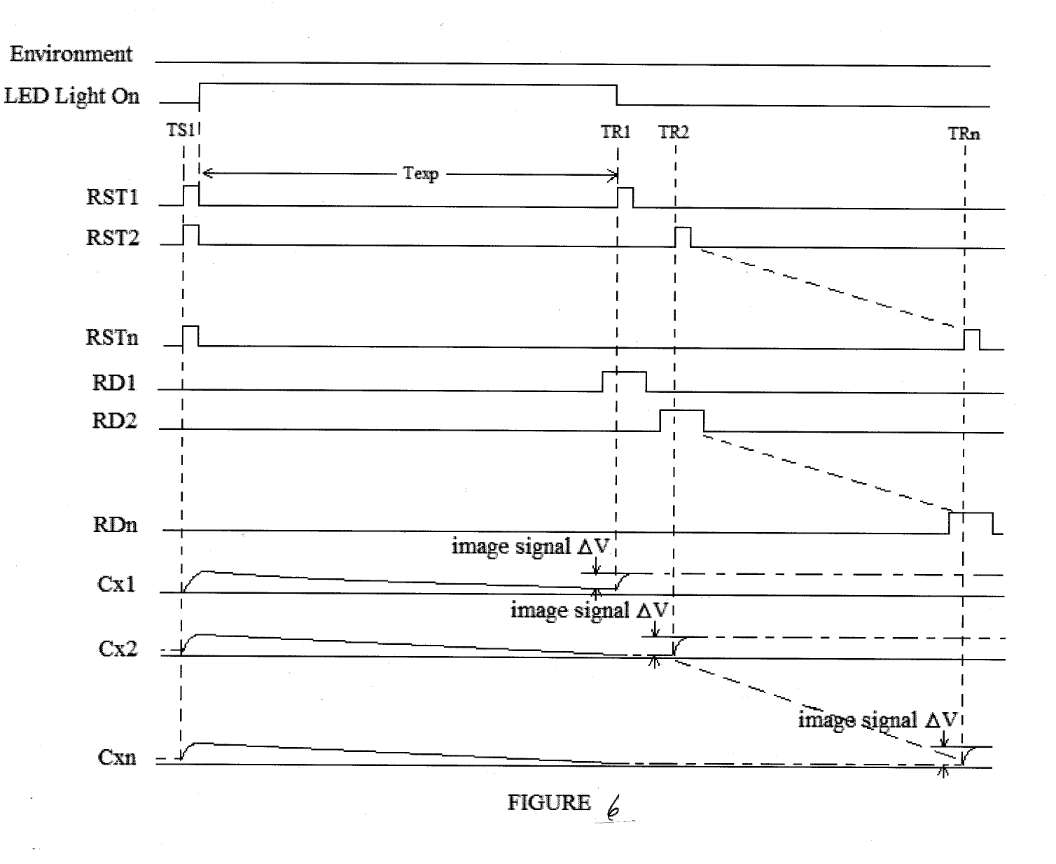

In a conventional CMOS image sensor (organized in the manner of the pixel cell array of FIG. 4), as illustrated by the signal timing diagram of FIG. 5, an image is captured by a rolling scanning scheme. As shown in FIG. 5, the rows of pixel cells are reset (i.e., precharged) by the pulses of reset signals RST1-RSTn at times TS1 to TSn, respectively, while the LEDs of illumination system 12 are turned on. Each of pulses RST1-RSTn brings the diode capacitor voltage of the pixel cells (i.e., the voltage at node Cx) in the corresponding row to a dark field reference. After substantially the same predetermined exposure time Texp, each row of pixel cells is read by a corresponding read-out signal (i.e., the corresponding one of RD1-RDn). The RD signal for each pixel cell is asserted for a time long enough to sense the voltage at node Cx, prior to the corresponding one of times TR1-TRn, when the RST signal for the pixel cell is asserted again. The asserted RST signal charges node CX towards VREF. However, because of the threshold voltage of reset transistor 302 and other factors, the voltage at Cx would not reach VREF. The voltage at node Cx is then sensed again. The voltage ΔV for each pixel cell, being the difference in voltage at node Cx sensed before and after the asserted RST signal, indicates the light received by the pixel cell. The RST pulse width is typically in the range of nanoseconds to tens of nanoseconds, while exposure time Texp ranges from tenths of a milliseconds to tens of milliseconds, so that the contribution by the RST pulse length to exposure time Texp can be neglected.

As shown in FIG. 5, to ensure that each row is exposed substantially the same exposure time (Texp), the LED is turned on substantially at time TS1 and remains on until time TRn, when RDn is asserted. In fact, because the LED light requires a finite amount of time to attain stability and to turn off, a margin is provide to allow the LED to be fully stabilized prior to time TS1, and to be turned off after time TRn. Hence, the total LED on-time substantially equals to (Texp+TRn−TR1). This long on-time requirement for the LED illumination system of a capsule camera is unnecessary, and represents an inefficient use of lighting power. Further, as the read-out times are staggered, the slanting artifact discussed above would appear, when the speed of the relative motion between the camera and the subject in the field of view is sufficiently large. When the speed of the relative motion is not uniform, the slanting artifact would make a perpendicular line appear as a distorted curve. This immediate read-out requirement imposes a very high transmission bandwidth requirement for a wireless capsule camera. For example, for a CIF image of about 75 k pixels resolution, if only one byte per pixel is transmitted, at a frame rate of 2 frames per second, 150 KB of data need to be transmitted. There is an upper bound for the total frame read-out time, practically at around 50 ms to avoid the slanting artifact. However, at two images per second, and which data must be transmitted as bursts over a total of no more than 100 ms, the required bandwidth is about 3 MB per second. This bandwidth cannot be achieved within the MICS band even with a high spectrum efficiency transmission scheme. One solution requires a frame buffer or a high image compression. The frame buffer required is in the order of 600K bits, which is very costly in material and power for the capsule camera application.

As to data compression, for a 422 color format image, the data is 150 k bytes or 1.2 M bits. Within the constraints of a capsule camera, in terms of both silicon estate and power consumption, the realistic compression ratio achievable is limited. A high compression ratio of 5 for a color image may require the power and silicon area of 100 k gates for a compression module, in addition to 240 k bits of buffer storage. To achieve a VGA resolution, 4 times the CIF image is preferred to achieve a desirable clinical detection rate. For such a VGA image, the cost is estimated to be 100 k gates plus about 1 M bits of buffering memory in silicon and about 4 times the power consumption of the CIF image.

Unlike the CMOS image sensor of a general purpose camera, however, a CMOS image sensor used under dark environment, for example a capsule camera for imaging a GI tract, the major sources of noise causing leakage currents are the dark current noise and system background noise. For this environment, the present invention provides an improved scanning scheme operating in conjunction a controlled LED light source; this method both achieves power savings and avoids the slanting artifact.

The present invention takes advantage of the fact that the capsule camera is designed to operate at body temperature, at which the leakage current in the CMOS pixel cell is substantially less than the maximum leakage current specified for a general-purpose camera. Thus, unlike a pixel cell in a general purpose camera, the timing requirements for pre-charge, exposure, and read out of a pixel cell in a capsule camera is relatively less stringent, as the charge in the pixel cell is expected to leak more gradually than the possible high leakage rate that may be expected in a general-purpose camera. Further, unlike a general-purpose camera, which must meet the externally imposed, varied lighting conditions, the lighting condition under which a capsule camera operates is primarily controlled by the LED of the capsule camera itself. The present invention takes advantage of these and other factors in the design of a capsule-camera, providing a specialized CMOS sensor of improved performance and at a lesser total system cost.

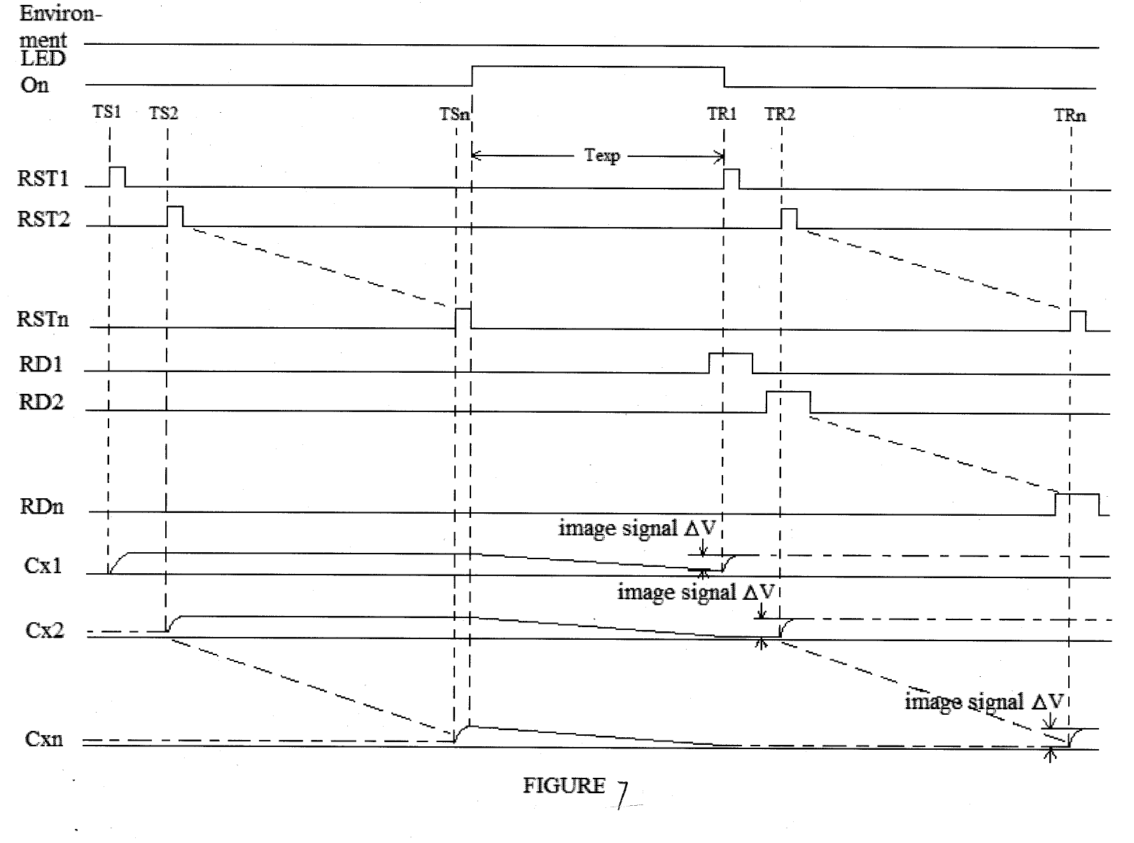

Thus, according to one embodiment of the present invention, illustrated by the scanning scheme of FIG. 6, an improved scanning scheme precharges all rows of pixel cells at substantially the same time TS1, at the time or slightly before the LED lighting is turned on. After the exposure time Texp, the LED lighting is turned off at time TR1, the rows of pixel cells are read sequentially by asserting read-out signals RD1-RDn, asserted respectively at times TR1-TRn. Under this scanning scheme, all pixel cells are exposed substantially concurrently, thus the slanting artifact is avoided. This scanning scheme is possible because the expected leakage current due to thermal noise for each pixel cell used in the capsule camera application is in the order of two decades less than that specified in a general purpose camera application. In addition, a number of pixel cells in the pixel cell array are specifically provided masked from light by opaque material (i.e., always kept in the dark) to provide a reference dark current. The reference dark current can be used to compensate the light intensity variations at different pixel cells due to their being measured at different times. This compensation avoids another artifact—which appears as a non-uniform shading across the image—due to the different times at which different rows of pixel cells are sensed. In addition, as the LED lighting is on only for the duration of the exposure time Texp, significant power is saved (hence longer battery life is achieved) over the conventional scanning scheme discussed above in conjunction with FIG. 5. The battery is expected to power at least several hours for the capsule camera's travel through the GI tract. A healthy battery that provides uniform power through its life time is important to provide high quality images, which are essential to increasing clinical detection rate and avoiding misinterpretation.

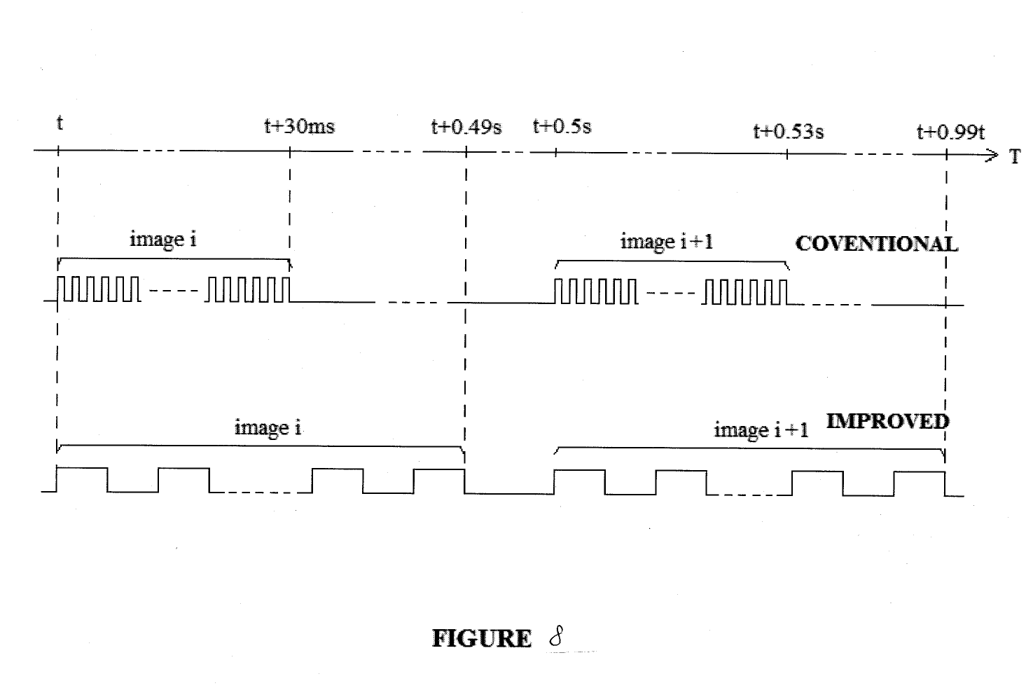

FIG. 7 illustrates another scanning scheme, according to another embodiment of the present invention. The scanning scheme of FIG. 7 recognizes that the photodiode junction capacitance (i.e., the capacitance of node Cx) may be as much as 10 ff. For a pixel cell array for a VGA image, which includes about 300 k pixel cells, the total capacitance may reach 3 nF. For a VREF of 3.0 volts, over a 10 ns pre-charge duration, a current in the order of 0.9 amps may result if all pixel cells are precharged concurrently. Such a current is far greater than can be supplied by a typical power supply system of a capsule camera. Thus, in FIG. 7, each row of pixel cells are pre-charged at a different time, at one of times TS1 to TSn, prior to LED lighting is turned on. The LED lighting is turned on after time TSn for an exposure time of Texp. Time TR1, when the voltage at node Cx of each pixel cell in row 1 is read, may arrive any time after the LED lighting is turned off. Thereafter, each row of pixel cells may be read out at times TR1s-TRn, as in the case illustrated by FIG. 6 discussed above. Again the variations in voltages read out due to different pre-charge times and read-out times can be compensated by the reference dark currents. Alternatively, the precharge time to read out time interval (i.e., the time interval between time TSi and time TRi, for the ith row) may be made substantially the same for each row to further avoid the non-uniform shading artifact.

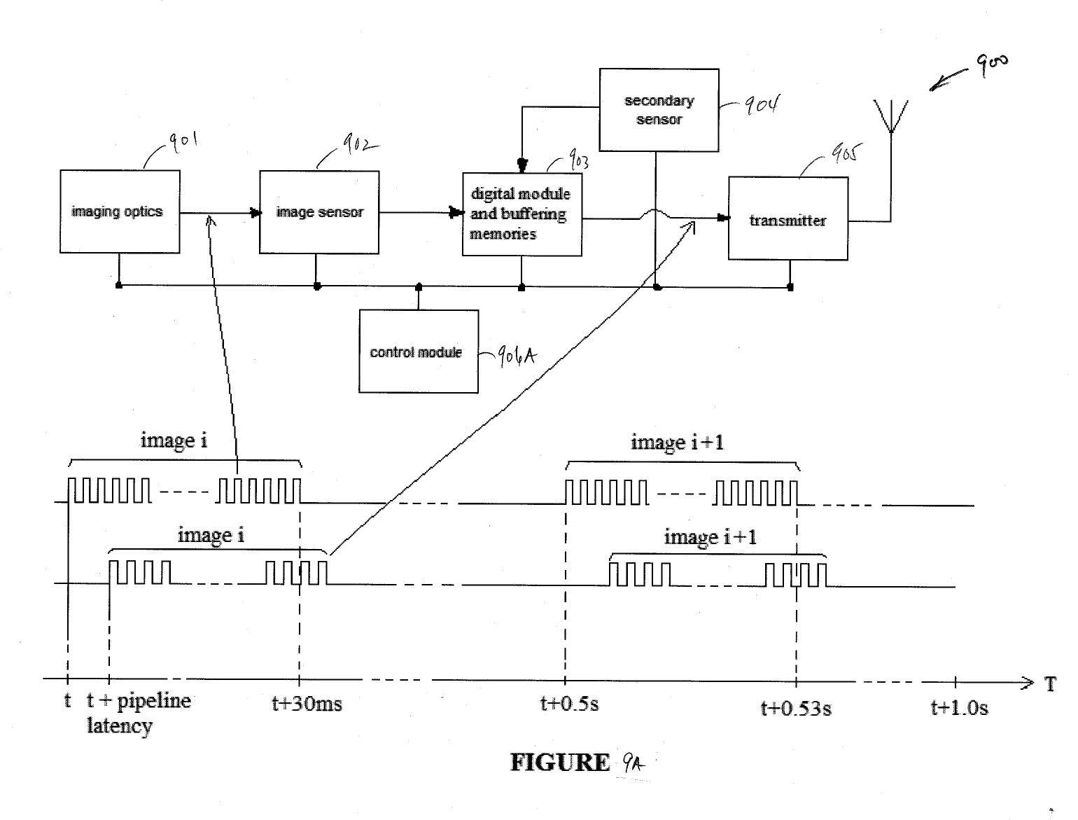

FIG. 8 compares the read out time for images for both conventional and the improved methods of FIGS. 6-7. As shown in FIG. 8, while the convention scanning scheme requires the image to be read out within 30 milliseconds, even though the images are captured at 2 frames a second, the methods of FIGS. 6-7 can spread out the read-out interval over the 0.5 second per frame. This is because, for the reasons already discussed above, the improved methods of the present invention need not observe the practical upper bound of approximately 50 ms for the read-out interval, imposed to avoid the slanting artifact. Unlike the conventional scanning scheme, the improved scanning schemes of the present invention read out the pixel cells without the stringent timing constraints, without incurring the slanting artifacts. Further, the LED illumination system (e.g., LED illumination system 12 of FIG. 1) is not required to be on during the read out interval (i.e., between times TR1 to TRn). Even further, by spreading out the read-out interval, the image data can be transmitted by wireless within the FCC mandated MICS band of 402 to 405 Mhz, as there is no longer the need for bursty transmissions of 50 ms or less durations. In a capsule camera using a non-volatile archival memory, the spreading out of the read-out times overcome also a similar bandwidth restriction due to the longer flash memory write time.

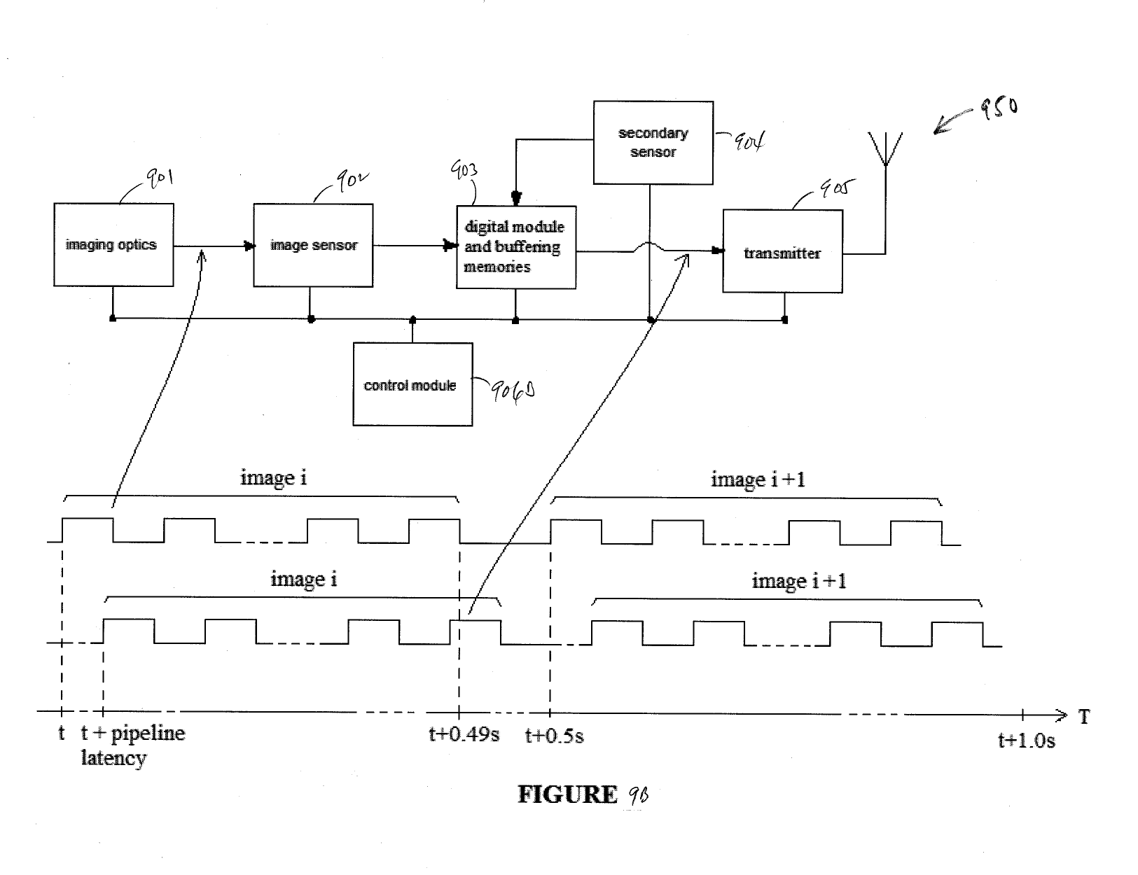

FIGS. 9A and 9B compare the operations of wireless capsule camera systems using the conventional scanning method and using the improved methods of the present invention, respectively. As shown in FIG. 9A, conventional wireless capsule system 900 includes imaging optics 901 (e.g., optical system 14 of FIG. 2), which provides an image to image sensor 902 (e.g., image sensor 16 of FIG. 2). An image captured by image sensor 902 is processed in digital signal processing modules and buffering memories 903 (e.g., image processor 18 of FIG. 2), along with any other data captured by secondary sensors 904 (e.g., temperature, pH). Digital signal processing functions performed may include movement detection, image compensation and data compression, for example. The processed data are then transmitted by transmitter 905 (e.g., transmitter 1326 of FIG. 2). Control module 906A (corresponding to control module 22 of FIG. 2) and sensor built-in circuits apply the conventional scanning method to bring the image on image sensor 902 into digital signal processing modules and buffering memories 903. To avoid the costs of a large random access memory (e.g., both material and power costs), modules 901-903 and 905 are typically pipelined. As shown in FIG. 9A, all the data for a single image from imaging optics 901 arrives at transmitter 905 after a short delay of the throughput time or pipeline latency, since there is no significant buffering between imaging optics 901 and transmitter 905, all the processed image data for that single image has to be transmitted over the 30 ms duration.

In contrast, FIG. 9B shows wireless capsule camera system 950 in which control module 906B executes one of the methods of the present invention. Because the image data for the single image is spread out over 0.49 seconds, even with the pipeline latency and the lack of buffering, transmitter 905 is able to have the entire image transmitted prior to the 0.5 seconds allocated for all processing of the image data, from exposure to transmission. In some embodiments, image sensor 902 may include built-in control circuits that provide local control of pre-charging and reading out of data from the pixel cells.

The detailed description above is provided to illustrate the specific embodiments of the present invention and is not intended to be limiting. Numerous modifications and variations within the scope of the present invention are possible. The present invention is set forth in the following claims.

I claim:

1. A method for reading out an image captured on a plurality of pixel cells in a pixel cell array, comprising:
Pre-charging the pixel cells in the pixel cell array;
Illuminating a field of view of the pixel cells for a predetermined exposure time; and
Reading-out data from the pixel cells only after the illuminating of the field of view is completed.

2. A method as in claim 1, wherein the pre-charging of the pixel cells is carried out over a predetermined time period prior to the field of view being illuminated.

3. A method as in claim 2, wherein a first portion of the pixel cells and a second portion of the pixel cells are precharged at different times.

4. A method as in claim 3, wherein the time interval between the precharging and the reading out of the pixel cells in the first portion is substantially the time interval between the precharging and the reading out of pixel cells in the second portion.

5. A method as in claim 1, wherein the reading out of data from the pixel cells is carried out over a predetermined time period greater than three times the predetermined exposure time.

6. A method as in claim 1, wherein the reading out of data from the pixel cells is carried out over a predetermined time period that is substantially the reciprocal of a frame rate at which images are captured at the pixel cell array.

7. A method as in claim 1, wherein the reading out of data from the pixel cells is further processed and transmitted by wireless to a receiver, the average data rate of transmission falling substantially within the allowable bandwidth of transmission under the FCC MISC band.

8. A method as in claim 1, wherein the reading out of data from the pixel cells is carried out over a predetermined time period greater than 50 ms.

9. A method as in claim 1, further comprising:
providing in the pixel cell array pixel cells that are masked from light; and
adjusting data read out from the pixel cells within the field of view by data read out from the pixel cells that are masked from light.

10. A method as in claim 1, wherein the time of illuminating the field of view is substantially the time of exposure at each pixel cell.

11. A capsule camera, comprising:
a pixel cell array having a plurality of pixel cells exposed to light from a field of view;
an illuminating system that illuminates the field of view;
a signal processor receiving and processing data from the pixel cell array; and
a control module that performs:
Pre-charging the pixel cells in the pixel cell array;
Illuminating a field of view of the pixel cells for a predetermined exposure time; and
Reading-out data from the pixel cells only after the illuminating of the field of view is completed.

12. A capsule camera as in claim 11, wherein the pre-charging of the pixel cells is carried out over a predetermined time period prior to the field of view being illuminated.

13. A capsule camera as in claim 12, wherein a first portion of the pixel cells and a second portion of the pixel cells are precharged at different times.

14. A capsule camera as in claim 13, wherein the pixel cell array comprises a plurality of rows of pixel cells, wherein the first and second portions of the pixel cells are provided on different rows of pixels.

15. A capsule camera as in claim 12, wherein the time interval between the precharging and the reading out of the pixel cells in the first portion is substantially the time interval between the precharging and the reading out of pixel cells in the second portion.

16. A capsule camera as in claim 11, wherein the reading out of data from the pixel cells is carried out over a predetermined time period greater than three times the predetermined exposure time.

17. A capsule camera as in claim 11, wherein the reading out of data from the pixel cells is carried out over a predetermined time period that is substantially the reciprocal of a frame rate at which images are captured at the pixel cell array.

18. A capsule camera as in claim 11, further comprising a transmitter that transmits processed data from the signal processor, wherein the processed data are transmitted at an average data rate falling substantially within the allowable bandwidth of transmission under the FCC MISC band.

19. A capsule camera as in claim 11, wherein the reading out of data from the pixel cells is carried out over a predetermined time period greater than 50 ms.

20. A capsule camera as in claim 11, further comprising a group of pixel cells outside of the field of view; and wherein the digital signal processor adjusts data read out from the pixel cells within the field of view by data read out from the pixel cells outside of the field of view.

21. A capsule camera as in claim 11, wherein the time of illuminating the field of view is substantially the time of exposure at each pixel cell.

22. A capsule camera as in claim 11, further comprising sensor built-in control circuits that perform the pre-charging and reading out in conjunction with the control module.
